(19) United States
(12) Patent Application Publication
(10) Pub. No.: US 2004/0220860 A1
(43) Pub. Date: Nov. 4, 2004

(54) Self-checkout system having integrated RFID reader

(76) Inventors: Michael Persky, New Canaan, CT (US); Steven J. Sanchez, St. Mary's, GA (US)

Correspondence Address: Brian P. Hopkins, Esq., Mintz, Levin, Cohn, Ferris, Glovsky & Popeo, P.C., The Chrysler Center, 666 Third Avenue, 24th Floor, New York, NY, 10017, US

(21) Appl. No.: 10/740,989

(22) Filed: Dec. 19, 2003

Related U.S. Application Data
(60) Provisional application No. 60/434,944, filed on Dec. 20, 2002.

(51) Int. Cl. G06F 17/60

(52) U.S. Cl. 705/23; 340/572.1; 340/5.92; 235/385

(57) ABSTRACT

Embodiments of the present invention are directed to systems and methods for conducting purchasing transactions using radio-frequency identification (RFID) of items for purchase. Such systems may include a security scale integral with a security conveyor for weighing one or more items placed thereon, a bagging area, a second conveyor for transporting items from the security conveyor to the bagging area, a lane controller for carrying out a purchasing transaction, payment means for accepting payment for the transaction, an RFID reader for receiving data from RFID tagged items and a database having item information stored therein. The system may write new information onto the tag. The system may utilize tag data for item validation and amending an item profile in a security database.

This application claims benefit under 35 U.S.C. § 119(e) of U.S. Provisional Application No. 60/434,944, filed Dec. 20, 2002, the entire disclosure of which is herein incorporated by reference.

### BACKGROUND OF THE INVENTION

1. Field of the Invention

The present invention relates to self-checkout systems that are deployed in a number of retail establishments, including supermarkets, wholesale warehouses, home improvement centers and general merchandisers.

2. Background

Self-checkout systems include a number of components similar to traditional checkout counters, including components for scanning, bagging and tendering customer orders. Additionally, current self-checkout systems have an array of article security methods that thwart consumer theft attempts. Security methods include article optical recognition of items, including, for example, height recognition, weight recognition and other item characteristic security features. In addition, transactions may be monitored using video surveillance.

Currently, items for purchase are identified in self-checkout systems using machine readable codes (e.g., UPC codes). Each item is scanned by a UPC scanner and the scanned in code is used to find pricing and security parameters of the item for the current transaction via a lookup table/database.

From time to time, new items are added to a retail establishment's product offering. In order for the item to be recognized by the system, and for the security system to perform accordingly, the item information for the newly added item must be added to the product database so that the self-checkout systems can access the data. If the item information is not added to the database prior to the item being available for purchase, any attempt to purchase the item by a customer will fail, requiring store personnel to address the situation. This usually leads to customer dissatisfaction due to at least the time delay in completing a transaction.

### SUMMARY OF THE INVENTION

The present invention presents novel systems and methods for self-checkout utilizing radio-frequency identification (RFID) technology. Thus, item information stored in the tag may be retrieved (as well as rewritten and/or amended) by one or more RFID readers provided for at a self-checkout lane, without having to access a lookup table to find product information. Alternatively, the information contained in the tag may be supplemented for the transaction by other item information contained in a database made available to the self-checkout system, or compared thereto.

In one embodiment of the invention, a self-checkout system may include a security area for recognizing a item characteristic, a lane controller for carrying out a purchasing transaction, payment means for accepting payment for the transaction and an RFID reader for receiving data from RFID tagged items. Such a security area may include a scale for weighing one or more items placed thereon.

In another embodiment of the present invention, a method for conducting the purchase of items using a self-checkout system may include providing a self-checkout system comprising a security area for recognizing a item characteristic, a lane controller for carrying out a purchasing transaction, payment means for accepting payment for the transaction and an RFID reader for receiving data from RFID tagged items, receiving item information from an RFID tag of an item that is passed proximate the RFID reader and transferring the item information to the lane controller for processing the transaction.

Where the item information comprises an item identification code, the method may further include accessing an item lookup table to find at least one of item price and item security characteristic. Where the item information comprises at least one of an item price and an item security characteristic, the method may further include entering the item price into the transaction and comparing a measured security characteristic value of the item with the item security characteristic obtained from the RFID tag of the item.

Embodiments of the present invention may also include computer readable media and computer application programs for carrying out the above method embodiment, or other method embodiment of the invention.

The above embodiments will become even more clear with reference to the attached drawings and following detailed description.

### BRIEF DESCRIPTION OF DRAWINGS

FIG. 1 is a line drawing of a self checkout system with RFID tag processing capability according to some embodiments of the invention.

FIG. 2 is a block diagram illustrating a local area network of self-checkout lanes in a retail establishment according to some embodiments of the invention.

FIG. 3 is a block diagram illustrating components of a lane controller according some embodiments of the invention.

FIG. 4 is a flowchart illustrating a transaction of an item for purchase with an RFID equipped self-checkout system according to some embodiments of the invention.

FIG. 5 is a flowchart illustrating a transaction of an item for purchase with an RFID equipped self-checkout system according to some embodiments of the invention.

### DETAILED DESCRIPTION OF THE EMBODIMENTS

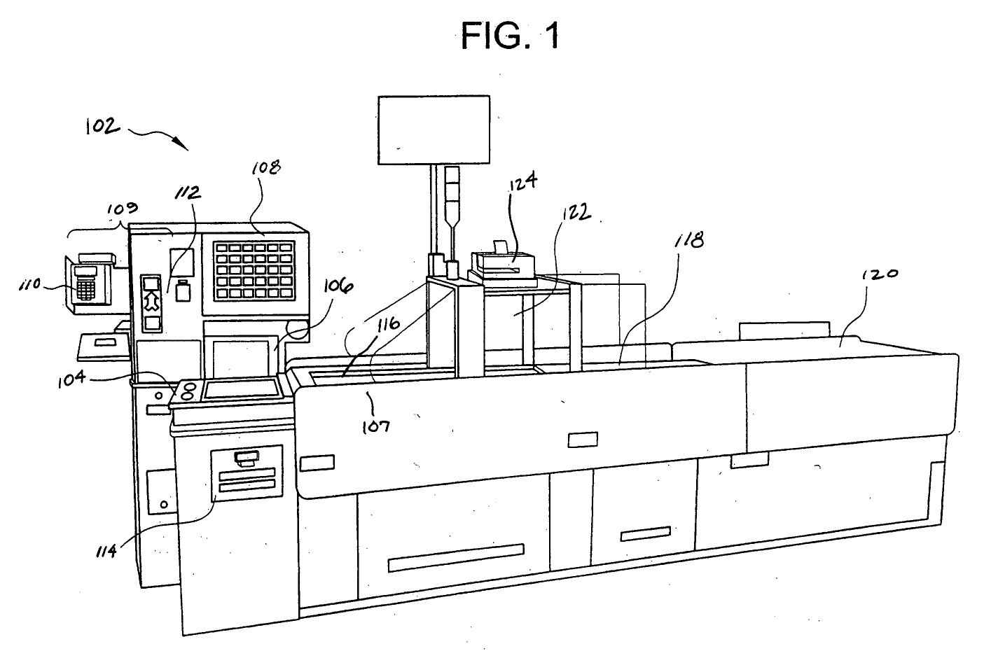

FIG. 1 is a representative illustration of a self-checkout lane 102 for embodiments of a self-checkout system according to the present invention. Each lane may include a lane controller (e.g., a computer system, see FIG. 3), a counter area 104, a universal product code (UPC) scanner 106, a radio-frequency identification reader 107 (e.g., which may be provided below a conveyor 116), a display screen 108 for interactive customer communication, payment mechanism 109, including credit card reader 110, cash acceptor 112 and cash dispenser 114 mechanisms, the entry/weighing (security) conveyor 116, an out-feed (second) conveyor 118, a bagging area 120, a security area 122, and a receipt unit 124.

The above described and illustrated lane may include a security system which uses the known weight of each item (or other physical item characteristic, for example) to protect against consumer fraud. Accordingly, in the illustrated embodiment, after the item is scanned, it is placed the security conveyor which weighs the item while transporting it through a security area 122. If the measured weight is within a predetermined tolerance of the predetermined weight of the item (e.g., listed in an item database), the item is transported toward a bagging area. If the weight of the item is not within the tolerance, the security conveyor is reversed and the shopper is requested to re-scan the item (for example), or, in non-conveyor system, the customer is alerted by the system that the measured item characteristic does not match. Such a system is disclosed in U.S. Pat. No. 4,676,343 (the '343 patent), the entire disclosure of which is incorporated herein by reference.

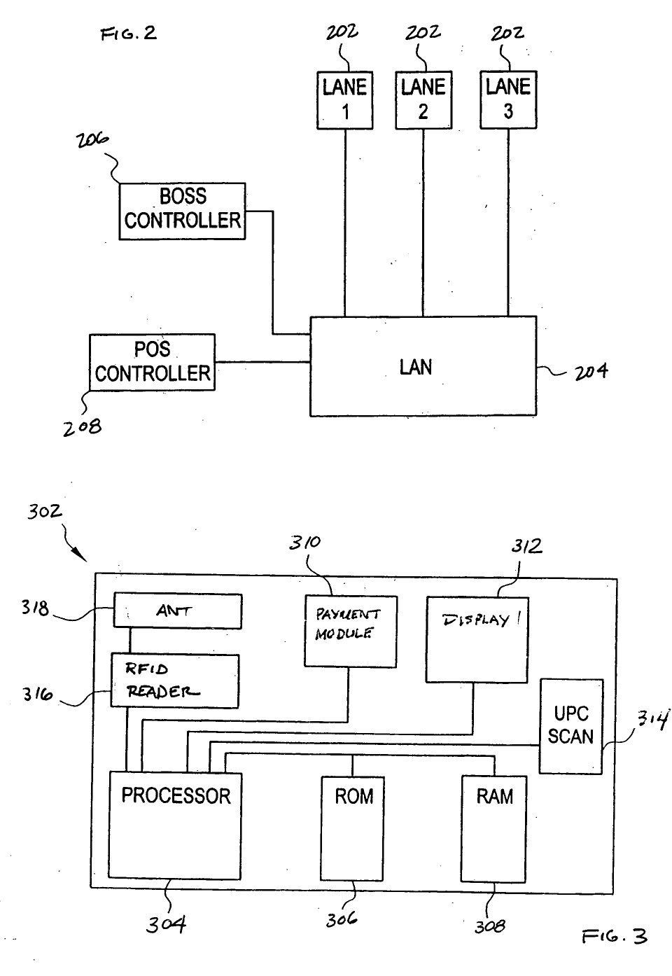

As shown in FIG. 2, a plurality of such lanes 202 may be linked to a local area network (LAN) 204, which is also linked with a BOSS controller 206 and a Point-Of-Sale (POS) Controller 208. The BOSS controller preferably manages database information for the lanes, i.e., all the information relating to the security aspects of items for purchase: volume, weight, dimensions, and the like. Supervisory personnel can update this database either at the BOSS controller or by updating a copy of the database at a particular lane. Synchronizing software stored in the lane and/or BOSS controller and run at predetermined intervals, allows updated database information to be passed from each lane to the controller, then from the controller to each lane. Thus, changes implemented at one lane will ultimately pass to the copy of the database stored at the other lanes.

Supervisory personnel may also use the BOSS controller to generate sales and lane performance reports, although such reports may be setup to run at a lane. One skilled in the art will appreciate, however, that an individual lane may be configured to operate as a BOSS controller if necessary, and that the present system does not require a BOSS controller to operate.

The POS controller manages the point of sale functions of the lanes, and also manages the pricing database for items (e.g., UPC database), including type-2 items, or, sold-by-weight items (i.e., meats, salads, and the like). The POS controller may be in communication with the lane controller at each lane independently, and its operation is not impacted by the presence (or lack of) the BOSS controller.

Each lane controller may also include a copy each of the pricing database from the POS controller as well as (as stated earlier) the security database from the BOSS controller. Thus, each lane may operate independently of those controllers over a period of time. Preferably, however, the self-checkout lanes are operated with the POS controller and BOSS controller so that changes implemented at one lane will be reflected at all lanes after a predetermined period of time.

As shown in FIG. 3, the lane controller 302 for the present invention may include a processor 304 in communication with a read-only memory (ROM) 306, for storing a control program (for example), and a random-access memory (RAM) 308 for storing other information during a transaction (e.g., database). The RAM may also be used as a temporary memory location the control program and other software. The processor may also be in communication with a payment module 310 which includes the cash distribution and collection devices as well as the credit/debit/ebt modules. At least one of the display 312, the UPC scanner 314, a keyboard (or other input device), and RFID reader 316 with accompanied antenna 318, as well as a security features controller (not shown) and/or other devices/systems of the self-checkout system, may also be in communication with the processor and/or memory.

The RFID reader, as included in some embodiments of the present invention, allows items tagged with RFID tags to transmit item information to the reader, which then relays the information to the lane controller. The information may include a name, price, weight, height, width, length, color, and the like, of the item being read by the reader. In present embodiments, the use of the RFID tag to transfer such data may eliminate the requirement of the lane controller to access any of the databases to retrieve the information. Alternatively, the databases may be used as an additional security parameter to compare the information received from the tag to that stored in the databases, or to obtain additional item information.

The RFID tag may be any type of RFID tag including an inductive tag, a battery operated tag, or a capacitively coupled tag. Inductive tags generally comprise a microprocessor and corresponding memory, a metal coil, and an encapsulating material. The metal coil may be copper or aluminum wire that is wound into a circular pattern on the transponder and acts as the tag's antenna. The tag transmits signals to the reader which comprise information from the memory. A read distance, the distance that the item (tag) is apart from the reader, is mainly dependent upon the size of the coil antenna. The encapsulating material may be a glass or polymer material. Typically, since a customer will pass a item/tag within one foot of the reader, the coil need not be large.

Inductive tags may be powered by a magnetic field produced by an antenna of the reader. The antenna picks up magnetic energy from the reader and communicates with the reader, by (for example) modulating the magnetic field. Thus, the tag may retrieve and/or transmit data from/to the reader.

Battery operated tags are similar to inductive tags, but may not require the magnetic field for transmitting information (i.e., the battery may be used for transmitting power). The battery power may also be used to keep memory intact. Alternatively, the tag may depend on the magnetic field for transmission power.

Capacitively coupled (CC) RFID tags are inductive tags which are cheaper than standard inductive tags and battery operated tags. CC RFID tags typically comprise a microprocessor and associated memory and conductive carbon ink to form the antenna. The two components are then attached to a paper label, which may be adhered to an item. Current available capacitively coupled RFID tags may hold up to 96 bits of information or more, which may provide enough room for an item's name, price, and security (e.g., weight) parameter. It is this type of RFID tag which is a preferred type of RFID tag to be used in a general retail environment, due to its simplicity and/or low cost, and is especially well suited for inexpensive goods such as food items in grocery stores. Additionally these tags may have the ability for a reader to write or amend new information onto them at the point of purchase.

The reader includes an antenna, which may be positioned at or near the UPC scanner location, although other locations in and around the lane may be used (e.g., security area, conveyor, etc.). The antenna emits the magnetic field and/or radio frequencies (depending upon which type of RFID tag/reader/system is used), for example, which activate the RFID tag on the item being scanned. The activated tag then sends the item data to the reader, which then passes the information to the lane controller. One of skill in the art will also appreciate that the reader may also be configured to write data to the tags obtained from the POS controller or a database after activation.

In one embodiment of the invention, the RFID tag may transmit all the necessary item information to the lane to conduct the transaction. In such an embodiment, the information may then be used for the transaction (price) and security processes (item characteristics). Moreover, the information may be relayed to the BOSS controller or other computer to track inventory, item purchases, customers, and the like.

In other embodiments of the invention, the RFID tag may only transmit certain information to the self-checkout system. In these embodiments, the lane controller uses the limited transmitted item information from the tag to obtain additional information from the item and/or security databases to complete the transaction for the item.

In still other embodiments of the invention, the RFID tag reader may transmit certain information from the self-checkout system to an RFID tag of the item. In these embodiments, at least one of the BOSS, POS and lane controllers may use the original transmitted information from the tag to obtain additional information from the item and/or security databases to amend the items tag before the transaction is completed.

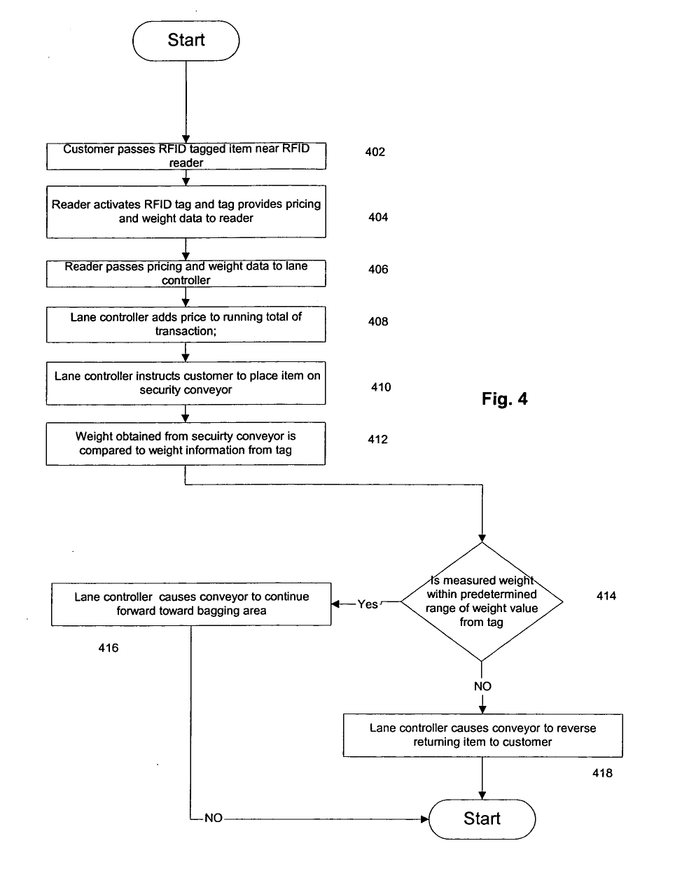

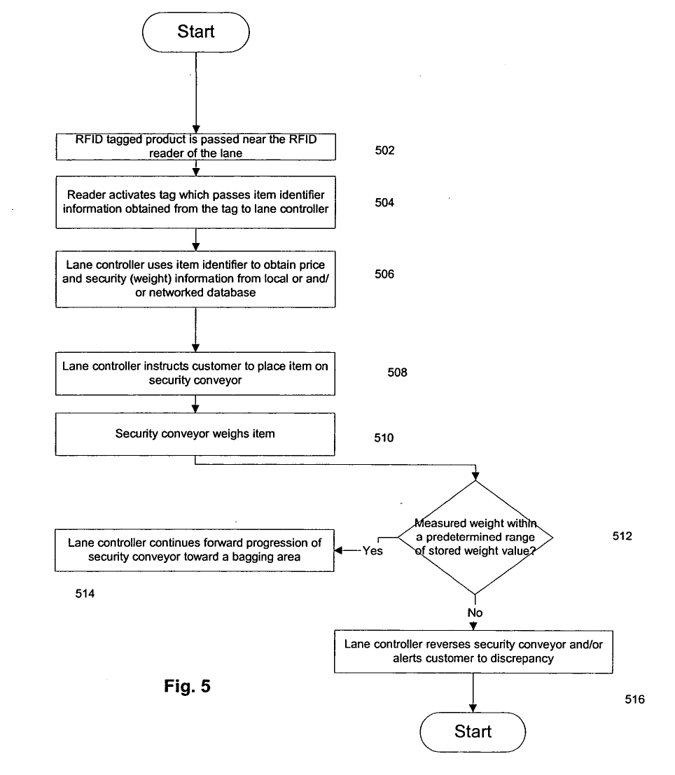

FIGS. 4 and 5 are flowcharts which illustrate exemplary self-checkout processes which utilize RFID technology. Accordingly, as shown in FIG. 4, after starting a self-checkout transaction, a customer passes an RFID tagged product near the scanning area, so that the RFID tag is activated by the RFID reader (402, 404). The tag then transmits at least one of pricing and weight data for the RFID tagged item, and/or more product information, to the reader (404). Upon receiving the data, the RFID reader then passes the information to a lane controller of the self-checkout lane (406). The lane controller then takes the price information and adds it to a running total for the shopping transaction (408). The lane controller, either currently with totaling the price information or slightly thereafter, instructs the customer to place the item on the security conveyor (or security scale or security characteristic measure system if no conveyor is included with the lane)(410). The security conveyor (according to one embodiment) then weighs the item and the lane controller, either directly or via a security controller (412), compares the measured weight with the weight obtained from the security tag (414).

If the actual weight of the item is within a predetermined tolerance of the weight value obtained from the RFID tag, then the lane controller allows the security conveyor to continue forward progression of the item toward a bagging area (416). Otherwise, the lane controller reverses the direction of the security conveyor and the item is returned to the scanning area (418). Of course, in a non-conveyor system, the lane controller may simply prompt the customer that there is a discrepancy with the measured characteristic versus the information from the RFID tag.

In the process outlined in FIG. 4, a product database may be accessed to either obtain additional information about the item which was read-in by the RFID reader, or to confirm the product information.

FIG. 5 illustrates a similar process as that illustrated in FIG. 4. However, in this example, the only information obtained from the tag is a product identification code (e.g., a UPC code or other item ID reference). The customer passes the RFID tagged item near a scanning area in the self-checkout lane (502). The RFID reader activates the tag which then passes item identification information to the reader (504), which then passes the information to the lane controller. The lane controller uses the item identifier to find product information in a product database (506). This process is similar to the process which occurs when scanning in a UPC code.

The lane controller then instructs the customer to place the item on the security conveyor (or security zone for measuring an item characteristic)(508), which then weighs (for example) the item (510). If the measured weight is within a predetermined tolerance range of the weight of the item obtained from the database, the lane controller (or via a security controller) continues forward progression of the security conveyor (or continues with allowing for additional item scans, for example, if there is no security conveyor)(514). Otherwise, the security conveyor is reversed (516).

While the present inventions have been described with a certain degree of particularity, it is obvious from the foregoing detailed description that one skilled in the art may make one or more modifications, which are suggested, by the above descriptions of the novel embodiments. Specifically, a number of other embodiments of the invention are possible, using RFID technology for all types of self-checkout systems (e.g., conveyor and conveyor-less), including, for example, the monitoring/checking of product expiration using RFID sensors, or a self-checkout system which does not use a measured item characteristic system for consumer fraud. For example, different sensors may be incorporated into the RFID tag, to sense product spoilage, weight (e.g., strain gauge), product electrical resistance, and the like.

What is claimed is:

1. A self-checkout system comprising
a security area for recognizing a item characteristic;
a lane controller for carrying out a purchasing transaction;
payment means for accepting payment for the transaction; and
an RFID reader for receiving data from RFID tagged items.

2. The self-checkout system according to claim 1, wherein the security area comprises a scale for weighing one or more items placed thereon.

3. The self-checkout system according to claim 1, further comprising a security conveyor including an integrated scale for weighing one or more items placed on the conveyor.

4. The self-checkout system according to claim 3, further comprising a second conveyor for transporting items from the security conveyor to a bagging area.

5. The self-checkout system according to claim 1, further comprising a database having item information stored therein.

6. The self-checkout system according to claim 1, wherein the RFID reader is capable of reading at least one RFID tag.

7. The self-checkout system according to claim 1, wherein the RFID reader is capable of accessing, rewriting information and/or writing new information onto at least one RFID tag.

8. The self-checkout system according to claim 2, wherein the RFID reader is integrated with the scale.

9. A method for conducting the purchase of items using a self-checkout system comprising:
providing a self-checkout system comprising a security area for recognizing a item characteristic, a lane controller for carrying out a purchasing transaction;
payment means for accepting payment for the transaction and an RFID reader for receiving data from RFID tagged items;
receiving item information from an RFID tag of an item that is passed proximate the RFID reader; and
transferring the item information to the lane controller for processing the transaction.

10. The method according to claim 9, further comprising transferring second information to the RFID tag from the self-checkout system.

11. The method according to claim 9, wherein the item information comprises an item identification code and wherein the method further comprises accessing an item lookup table to find at least one of item price and item security characteristic.

12. The method according to claim 11, further comprising entering the item price into the transaction and comparing a measured security characteristic value of the item with the item security characteristic from the lookup table.

13. The method according to claim 9, wherein the item information comprises at least one of an item price and an item security characteristic.

14. The method according to claim 13, further comprising entering the item price into the transaction and comparing a measured security characteristic value of the item with the item security characteristic obtained from the RFID tag of the item.

15. A computer readable medium having computer instructions provided thereon for performing a method for conducting the purchase of items using a self-checkout system, the method comprising:
providing a self-checkout system comprising a security area for recognizing a item characteristic, a lane controller for carrying out a purchasing transaction, payment means for accepting payment for the transaction and an RFID reader for receiving data from RFID tagged items;
receiving item information from an RFID tag of an item that is passed proximate the RFID reader; and
transferring the item information to the lane controller for processing the transaction.

16. A computer application program operable on a computer system of a self-checkout system for performing a method for conducting the purchase of items using a self-checkout system, the method comprising
providing a self-checkout system comprising a security area for recognizing a item characteristic, a lane controller for carrying out a purchasing transaction, payment means for accepting payment for the transaction and an RFID reader for receiving data from RFID tagged items;
receiving item information from an RFID tag of an item that is passed proximate the RFID reader; and
transferring the item information to the lane controller for processing the transaction.

17. A self-checkout system comprising
a security scale integral with a security conveyor for weighing one or more items placed thereon;
a bagging area;
a second conveyor for transporting items from the security conveyor to the bagging area;
a lane controller for carrying out a purchasing transaction;
payment means for accepting payment for the transaction;
an RFID reader integrated with the security scale for receiving data from RFID tagged items; and
a database having item information stored therein.
